(19) United States
(12) Patent Application Publication
(10) Pub. No.: US 2020/0071563 A1
(43) Pub. Date: Mar. 5, 2020

(54) AMPHIPHILIC SURFACE-SEGREGATING POLYMER MIXTURES

(71) Applicants: THE GENERAL HOSPITAL CORPORATION, Boston, MA (US); TUFTS UNIVERSITY, Medford, MA (US)

(72) Inventors: Osman Berk Usta, Swampscott, MA (US); Ayse Asatekin Alexiou, Arlington, MA (US); Ayse Aslihan Gokaltun, Boston, MA (US)

(21) Appl. No.: 16/492,989

(22) PCT Filed: Mar. 16, 2018
(86) PCT No.: PCT/US2018/022911

§ 371 Date: Sep. 11, 2019

Related U.S. Application Data
(60) Provisional application No. 62/472,306, filed on Mar. 16, 2017.

(51) Int. Cl. C09D 183/04; C09D 5/00; B01L 3/00

(52) U.S. Cl. CPC C09D 183/04; C09D 5/00; B01L 3/502707; B01L 2300/161; B01L 2300/12; B01L 2300/165; B01L 2200/10

(57) ABSTRACT

A segregated polymeric material is described that includes a silicon-based hydrophobic polymer and a copolymer comprising a silicon-based hydrophobic polymer and a hydrophilic segment, wherein the copolymer has been segregated to a surface of the material by contacting the surface with an aqueous solution. The segregated polymeric material can be used to improve the wettability and decrease the protein adsorption of a surface.

### CONTINUING APPLICATION DATA

This application claims the benefit of U.S. Provisional Application Ser. No. 62/472,306, filed Mar. 16, 2017, the disclosure of which is incorporated by reference herein.

### GOVERNMENT SUPPORT

This invention was made with government support under grant numbers 5P41EB002503 and 1R1EB02019201A1, awarded by the National Institutes of Health, and grant number CBET-1553661, awarded by the National Science Foundation. The government has certain rights in the invention.

### BACKGROUND

The microfluidics industry already encompasses a $2-4 billion market, expected to grow by ˜18%/year to $10-20 billion by the 2020s. Academic interest is growing at a similarly fast pace with the number of publications on microfluidics doubling every 15 months. This growth is driven mainly by biomicrofluidics such as point of care devices, drug manufacturing micro-reactors, toxicity screening with organs-on-chips, and microneedles/pumps for drug delivery. However, choosing the right materials is critical for avoiding artifacts and reduced sensitivity in biomedical and diagnostic applications, including those that can arise from the adsorption of compounds of interest onto surfaces.

Poly(dimethyl siloxane) (PDMS) and other silicone elastomers offer a range of favorable properties for biomicrofluidics applications, including: (1) simple fabrication by replica molding, (2) good mechanical properties, (3) excellent optical transparency from 240 to 1100 nm, (4) biocompatibility and non-toxicity, and (5) high gas permeability. van Poll et al., Angew Chem Int Ed Engl 46, 6634-6637 (2007) Despite these merits, the hydrophobicity of PDMS (water contact angle ˜108°±7°) often limits its applications where solutions comprising biological samples are concerned. Wu et al., Biomed Microdevices 8, 331-340 (2006) The hydrophobicity of the PDMS surface results in undesired non-specific adsorption of proteins, which in turn affects analyte transportation and reduces separation performance and detection sensitivity. Belder, D. & Ludwig, M., Electrophoresis 24, 3595-3606 (2003) Also, the high hydrophobicity of PDMS microchannels makes it difficult to introduce aqueous solutions or mixtures of aqueous and organic solutions. Hu, S. et al., Anal Chem 74, 4117-4123 (2002) Since most of the work in microfluidics relies on using polar liquids, this causes a significant obstacle in many applications. This has led many groups to develop approaches to render the PDMS surface hydrophilic and resistant to protein adsorption. Gokaltun et al., Technology (Singap World Sci) 5, 1-12 (2017) These strategies include the use of high-energy treatments in the form of O₂ plasma, UV/ozone treatments, and corona discharges to oxidize PDMS surfaces and to introduce alkoxy- or chloro-silanes for surface functionalization later on, coating of PDMS surfaces with polar functionalities using charged surfactants (Dou et al., Electrophoresis 23, 3558-3566 (2002)), polyelectrolyte multilayers (PEMs; Decher, G., Science 277, 1232-1237 (1997)), chemical vapor deposition (Xu, J. & Gleason, K. K., Chemistry of Materials 22, 1732-1738 (2010)), silanization (Zhang et al., Lab on a Chip 9, 3185-3192 (2009)), phospholipid bilayer (Mao et al., Analytical chemistry 74, 379-385 (2002)), and more recently generating hydrophilic polymers to or from the surface of PDMS via grafting-from and grafting-to approaches (Hu, S. & Brittain, W. J., Macromolecules 38 6592-6597 (2005)), hydrosilylation (Chen et al., Analytical Chemistry 80, 4119-4124 (2008)) and click chemistry (Zhang et al., Electrophoresis 31, 3129-3136 (2010)).

While these interventions have proved successful in improving surface hydrophilicity, their broader use was often restricted by limited chemical stability, the need for special equipment and/or hazardous routes, and/or the length and complexity of their process for fabrication that is restrictive for large-scale implementation. Gomez-Sjoberg et al., Anal Chem 82, 8954-8960 (2010). In addition, many of these methods are difficult to carry out inside microdevices. More recently, a study was reported to produce permanently hydrophilic silicone elastomers, but the necessary chemical steps for modification limited its application in microfluidic channels. Other complications when using existing PDMS modification approaches include loss of transparency, change in mechanical properties, surface cracking and increased roughness. Asatekin et al., Journal of Membrane Science 298, 136-146 (2007) Finally, most of these methods do not provide a hydrophilic surface long term. Due to the mobility of PDMS chains, the surface becomes hydrophobic again over time, negating the initial benefits of treatment. Hu et al., Electrophoresis 24, 3679-3688 (2003) These issues curtail the benefits of these PDMS surface modification methods, and emphasize the need for a new approach.

An alternative approach for creating more hydrophilic and fouling-resistant surfaces involves the use of surface-segregating smart copolymers. In this approach, an amphiphilic copolymer additive is blended with the base polymer before the manufacture of the final component. The hydrophilic sections of the copolymer drive it to the polymer/water interface, leading to surface segregation. When successful, this results in increased surface hydrophilicity, but only minor changes in bulk properties. This approach has been previously used in other fields and base materials. For instance, it enabled the preparation of filtration membranes with excellent, complete fouling resistance made of polyacrylonitrile (PAN; Kang et al., Journal of Membrane Science 29615 J, 42-50 (2007)) and poly(vinylidene fluoride) (PVDF). Kaner et al., Journal of Membrane Science 533, 141-159 (2017) It was also used to prevent non-specific adsorption and cell adhesion on poly(methyl methacrylate) (PMMA) surfaces. Walton et al., Macromolecules, 30, 6947-6956 (1997).

Similarly, the use of amphiphilic or hydrophilic additives to PDMS during the manufacture of devices can lead to improved hydrophilicity. This approach is simple, often not requiring any additional steps. If designed well, it can potentially lead to mechanical and optical properties similar to unmodified PDMS. However, only a few studies have focused on functionalizing the PDMS surface through a pre-mixing method, where functional additives are added to the liquid PDMS pre-polymer before curing. In some cases, the objective of such studies was not to improve hydrophilicity but rather to introduce specific functional groups on the surface. For example, Zare et al. added a biotinylated phospholipid (1,2-dioleoyl-sn-glycero-3-phosphoethanolamine-N-(biotinyl) (Bio-DOPE)) to PDMS prepolymer to enable protein immobilization. Huang et al., Lab Chip 6, 369-373 (2006). Another study introduced charged groups to PDMS microfluidic channels by adding a carboxylic acid (undecylenic acid) to the pre-polymer prior to curing. Luo et al., Anal Chem 78, 4588-4592 (2006) This led to an increased electroosmotic flow (EOF) in PDMS microchannels, improving the separation efficiency and reducing the peak broadening in PDMS microfluidic devices. Both studies revealed the same the surface hydrophobicity as unmodified PDMS.

Other researchers have tested additives to improve surface hydrophilicity. For instance, Zhou et al. added vinyl-terminated polyethylene glycol (PEG) chains to PDMS before curing, showing a slight a decrease in the water contact angle (WCA) from 112° to about 78°, accompanied by improved resistance to non-specific adsorption of a protein. Zhou et al., Anal Chem 81, 6627-6632 (2009). In another study, PDMS microchips were prepared via adding a poly(lactic acid)-poly(ethylene glycol) (PLA-PEG) amphiphilic diblock copolymer before curing. Xiao et al., Electrophoresis 28, 3302-3307 (2007). These microchips exhibited reduced myoglobin adsorption, and a slightly lower WCA of 84° and 73° for 1.5 and 2% mass ratio of PLA-PEG to PDMS. The amphiphilic triblock copolymer Pluronic (PEG-b-poly(propylene oxide)-b-PEG) was used as such an additive. Wu, Z. & Hjort, K., Lab Chip 9, 1500-1503 (2009) Upon filling the PDMS microfluidic channel with water, Pluronic embedded in PDMS segregated towards the water/PDMS interface due to the high gradient between the PDMS substrate and water. The static contact angle of modified PDMS surface changed from 98.6° to 63° after soaking the sample in water for 24 hours, whereas that of the additive-free PDMS remained around 103°. Furthermore, thanks to the improved hydrophilicity, compared to unmodified PDMS, the modified surface suppressed the non-specific adsorption of Immunoglobulin G (IgG). However, the limited compatibility of the hydrophobic poly(propylene oxide) segments with PDMS can limit the success of this approach. Indeed, the researchers observed samples became cloudy with as little as 0.16% Pluronic. Furthermore, the Pluronic surfactant is water soluble, which led to some leaching during use. This may lead to the degradation of surface hydrophilicity in time, and affect cell viability.

Fang et. al utilized PDMS-b-PEG block copolymer additive to hydrophilize the PDMS surface. Yao, M. & Fang, J., J. Micromech. Microeng. 22, 1-6 (2012) In their study they used different PDMS-b-PEG additive concentrations (0.2-1.9 w/w %) to investigate the change in WCA and bonding properties of modified PDMS to silicon and glass. The static contact angle of modified PDMS was between 21.5°, 80.9° when the additive concentrations were 1.9% and 0.2% respectively. Also they bonded modified PDMS on silicon wafer to test the flow of the liquid in the channel with capillary action. Nevertheless, this study has deficiencies in surface characterization, long term stability and also mechanical and optical properties of modified samples. Also, none of the studies that focus on surface modification using additives tested their materials for biocompatibility. However, the additives are typically surfactants that are water-soluble and can cause cell rupture. Therefore, it is important to test any such new approaches for biocompatibility to ensure its usability in realistic systems in contact with cells, such as organs-on-chips.

### SUMMARY OF THE INVENTION

Poly(dimethylsiloxane) (PDMS) is probably the most popular material of choice for lab-on-a-chip and other biomedical applications. A key challenge that limits the use of PDMS is its high hydrophobicity, which leads to non-specific adsorption of proteins, as well as small hydrophobic molecules such as therapeutic drugs. The inventors have developed a novel method for modifying PDMS materials to improve hydrophilicity and decrease non-specific protein adsorption while retaining cellular biocompatibility, transparency, and good mechanical properties without the need for any post-cure surface treatment. This approach utilizes block copolymers (BPC) comprised of polyethylene glycol (PEG) and PDMS segments (PDMS-PEG) that, when blended with PDMS during device manufacture, spontaneously segregate to surfaces in contact with aqueous solutions and reduce the hydrophobicity without added manufacturing steps. PDMS with PDMS-PEG BPC showed significantly lower water contact angle compared to PDMS with no PDMS-PEG, and retained this hydrophilicity for at least nine months. Modified devices exhibited considerably reduced non-specific adsorption of albumin, lysozyme, and immunoglobulin G. Biocompatibility of the modified PDMS was also tested with a simple liver-on-a-chip model using primary rat hepatocytes, displaying no adverse effects. Finally self driven microfluidic devices were fabricated with this approach and exhibited steady flow rates, which could be tuned by the device geometry. It is expected that this segregated polymer material can be further applied in analytical separations, biosensing, cell studies and drug-related studies.

### BRIEF DESCRIPTION OF THE FIGURES

The present invention may be more readily understood by reference to the following figures wherein:

FIG. 1 provides a schematic diagram of PDMS surface modification. PDMS and the PDMS-PEG BPC additives are blended, and the device is fabricated following usual processes (i.e., no added steps). The copolymers segregate to the PDMS surface in air. When in contact with water, surface rearrangement creates a surface covered with PEG groups that prevent non-specific adsorption of proteins and allows flow of polar liquids.

FIGS. 2A-2C provide graphs and images showing PDMS with PDMS-PEG BPC additives dramatically reduces hydrophobicity. (a) The change in WCA with time for various additive ratios (0.125-2%), showing polymer reorganization. (b) WCA of PDMS with/without PDMS-PEG BPC additives. (c) Final (t=45 min) WCAs for different PDMS-PEG BPC additive ratios after 9 months of storage (with/without plasma treatment) show the stability of the modified materials. This was to show that the surface does not lose its hydrophilic characteristics for a long time period. The data are shown as the mean±SD (n=3).

FIGS. 3A and 3B provide graphs showing high-resolution scans of C1s spectra of (a) PDMS with no PDMS-PEG BPC additive and (b) PDMS with 0.25% PDMS-PEG BPC additive before IPA soaking (BS), after IPA soaking (AS), after IPA soaking and 1 day after O₂ plasma treatment (AS+PT-1 d) and after IPA soaking and 1 week after O₂ plasma treatment (AS+PT-1 wk) were analyzed. The existence and reorientation of the copolymers to the surface were proven by XPS. XPS of each sample were obtained by taking and average of 5 scans for survey spectrum and 10 scans for high resolution scan data.

FIG. 4 provides images showing the bio-compatibility of PDMS with PDMS-PEG BPC additives. Rat hepatocytes were cultured in glass-(PDMS-PEG BPC modified) PDMS devices. No adverse effects were observed (3 days) with (a) PDMS with no PDSM-PEG and PDMS with (b) 0.125%, (c) 0.25%, (d) 0.5% and (e) 1% (w/w) PDMS-PEG BPC. Image scale bar: 400 μm. Each experiment was conducted in triplicates from at least three different rat isolations.

FIGS. 5A-5C provide graphs and images showing PDMS with PDMS-PEG BPC additives reduces protein adsorption. a) Adsorption of fluorescently labeled albumin and lysozyme onto BPC modified PDMS slabs. Samples were covered with protein solutions for 30-90 minutes. PDMS with PDMS-PEG BPC additive showed high adsorption, whereas PDMS modified with 1% w/w PDMS-PEG block copolymer exhibited significantly lower adsorption, near detection limit (n=3). Image scale bar: 400 μm. b) Adsorption of IgG, BSA, and lysozyme was measured in modified microfluidic devices, comparing the influx and efflux concentrations. PDMS-PEG BPC additive leads to significantly reduced adsorption for all proteins. Error bars represent standard deviation with samples measured in triplicate (n=3).

### DETAILED DESCRIPTION OF THE INVENTION

This disclosure provides a segregated polymeric material that includes a silicon-based hydrophobic polymer and a copolymer comprising a silicon-based hydrophobic polymer and a hydrophilic segment, wherein the copolymer has been segregated to a surface of the material by contacting the surface with an aqueous solution. The segregated polymeric material can be used to improve the wettability and decrease the protein adsorption of a surface, such as the surface of a microfluidic device.

### Definitions

Unless otherwise defined, all technical and scientific terms used herein have the same meaning as commonly understood by one of ordinary skill in the art to which this invention pertains. In case of conflict, the present specification, including definitions, will control.

The terminology as set forth herein is for description of the embodiments only and should not be construed as limiting of the invention as a whole. Unless otherwise specified, “a,” “an,” “”the,” and “at least one” are used interchangeably. Furthermore, as used in the description of the invention and the appended claims, the singular forms “a”, “an”, and “the” are inclusive of their plural forms, unless contraindicated by the context surrounding such.

As used herein, reference to a group being a particular polymer (e.g., polyethylene glycol or polydimethylsiloxane) encompasses polymers that contain primarily the respective monomer along with negligible amounts of other substitutions and/or interruptions along polymer chain. In other words, reference to a group being a polyethylene glycol group does not require that the group consist of 100% ethylene glycol monomers without any linking groups, substitutions, impurities or other substituents (e.g., alkylene substituents). Such impurities or other substituents can be present in relatively minor amounts so long as they do not affect the functional performance of the compound, as compared to the same compound containing the respective polymer substituent with 100% purity.

“Biocompatible,” as used herein, refers to any material that does not cause injury or death to the animal or induce an adverse reaction in an animal when placed in intimate contact with the animal's tissues. Adverse reactions include for example inflammation, infection, fibrotic tissue formation, cell death, or thrombosis. The terms “biocompatible” and “biocompatibility” when used herein are art-recognized and mean that the referent is neither itself toxic to a host (e.g., an animal or human), nor degrades (if it degrades) at a rate that produces byproducts (e.g., monomeric or oligomeric subunits or other byproducts) at toxic concentrations, does not cause prolonged inflammation or irritation, or does not induce more than a basal immune reaction in the host. It is not necessary that any composition have a purity of 100% to be deemed biocompatible. Hence, a composition may comprise 99%, 98%, 97%, 96%, 95%, 90% 85%, 80%, 75% or even less of biocompatible agents, e.g., including polymers and other materials and excipients described herein, and still be biocompatible.

Also herein, the recitations of numerical ranges by endpoints include all numbers subsumed within that range (e.g., 1 to 5 includes 1, 1.5, 2, 2.75, 3, 3.80, 4, 5, etc.).

### Segregated Polymeric Material

In one aspect, the present invention provides a segregated polymeric material. The segregated polymeric material comprises a silicon-based hydrophobic polymer and a copolymer comprising a silicon-based hydrophobic polymer and a hydrophilic segment, wherein the copolymer has been segregated to a surface of the material by contacting the surface with an aqueous solution. The segregated polymeric material is amphiphilic, in that one side of the polymeric material is relatively hydrophilic, while the other side of the polymeric material is relatively hydrophobic. This provides a material that has both good wettability and protein adherence characteristics, while retaining a hydrophilic side that can be readily bonded to a variety of materials. In some embodiments, the segregated polymer material is transparent, which can be important for a number of analytic applications.

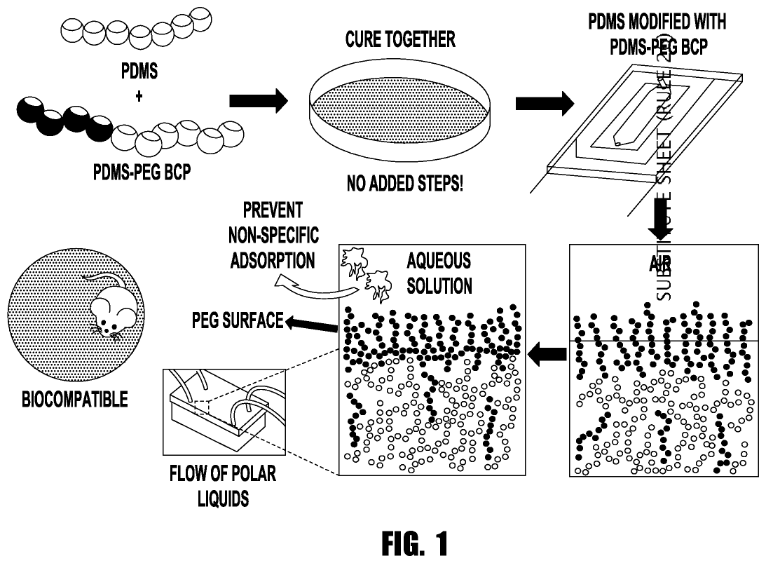

A segregated polymeric material, as used herein, refers to a polymer mixture including a hydrophobic polymer and a relatively hydrophilic copolymer in which the hydrophilic copolymer is not evenly mixed with the hydrophobic polymer, but rather has preferentially accumulated in one portion of the polymer. Segregation, as used herein, does not imply that the hydrophilic copolymer mixture is absent from other regions of the polymer material, but rather that it is present in one region or regions in a higher amount than in other regions. The segregated regions of the polymer include relatively hydrophilic regions including a higher amount of the hydrophilic copolymer relative to other regions (i.e., a segregated hydrophilic layer), and relatively hydrophobic regions including a higher amount of the hydrophobic polymer relative to other regions (i.e., a segregated hydrophobic layer). In some embodiments, the segregated polymeric material comprises essentially two regions (i.e., a hydrophilic and a hydrophobic region) while in other embodiments the segregated polymeric material comprises a gradual gradient between a hydrophilic and hydrophobic region, with various values within the gradient. Typically, the segregated polymeric material described herein is segregated as a result of exposure of the polymeric material to an aqueous solution, which causes the hydrophilic copolymer to segregate towards the surface of the polymeric material that is exposed to the aqueous solution. Segregation of the polymeric mixture is shown in FIG. 1. As shown in FIG. 1, exposure to an aqueous solution can also alter the orientation of the hydrophilic copolymer such that the hydrophilic segments of the copolymers are primarily directed towards the aqueous solution.

The segregated polymeric mixture includes a silicon-based hydrophobic polymer and a copolymer comprising a silicon-based hydrophobic polymer and a hydrophilic segment. Preferably the copolymer is present in a lesser amount than the hydrophobic polymer. In some embodiments, the copolymer comprises from 0.1% to 10% of the polymeric mixture by weight. In another embodiment, the polymeric material comprises from 0.1% to 5% of the copolymer, while in yet another embodiment the polymeric the material comprises from 0.1% to 1.5% of the copolymer. In a further embodiment, the polymeric material comprises from 0.1% to 1% of the copolymer, while in yet another embodiment the polymeric material comprises from 0.5% to 2.5% of the copolymer by weight.

The segregated polymeric material can be used in a variety of applications and formed into a variety of shapes. For example, in some embodiments, sheets of the segregated polymeric material are used. In other embodiments, the segregated polymeric material is formed into tubing. In other embodiments, the segregated polymeric mixture can be applied as a coating, or used to manufacture a device such as a microfluidic device. The segregated polymeric materials can be used for a variety of applications where modified surface characteristics are desired. For example, the segregated polymeric materials can be used to modify a surface to decreased biofouling of surfaces exposed to environments where microorganisms reside.

The segregated polymeric materials can also be used to increase biocompatibility, or increase the usefulness of the material for biomaterial applications where increased wettability is desired. For example, the segregated hydrophilic layer of the segregated polymeric material will have a contact angle less than that of the silicon-based hydrophobic polymer itself. In some embodiments, the segregated hydrophilic layer of the segregated polymeric material has a contact angle of 5% or less, 10% or less, 20% or less, 30% or less, 40% or less, 50% or less, 60% or less, 70% or less, or 80% or less. In addition, the segregated polymeric material can also provide a lower non-specific adsorption of materials such as proteins. In some embodiments, the segregated hydrophilic layer of the segregated polymeric material adsorbs at least 50% less or at least 60% less or at least 80% less or at least 90% less or at least 100% less protein compared with a surface consisting of the silicon-based hydrophobic polymer. Because the segregated polymeric materials are often used in biomicrofluidic applications, it is preferable that the segregated polymeric materials are biocompatible.

The segregated polymeric material comprises a silicon-based hydrophobic polymer and a copolymer comprising a silicon-based hydrophobic polymer and a hydrophilic segment. A variety of silicon-based hydrophobic polymers can be used in the segregated polymeric material. Examples of silicon-based hydrophobic polymers include polydimethylsiloxane (PDMS) and PDMS derivatives (e.g., bisamino-propyl PDMS).

The segregated polymeric material also includes a copolymer. The copolymer includes a silicon-based hydrophobic polymer segment and a hydrophilic segment. The silicon-based hydrophobic polymer segment can be the same silicon-based hydrophobic polymer present in the segregated polymeric material, or it can be a different silicon-based hydrophobic polymer. The two segments are joined together to form the copolymer. Examples of suitable types of copolymers include block, graft, or mixed bottle brush structure copolymers. The copolymer includes a silicon-based hydrophobic polymer segment to make it compatible with the silicon-based hydrophobic polymer included in the segregated polymeric mixture, while the hydrophilic segment of the copolymer modifies the polymeric material to increase is hydrophilicity.

In some embodiments, the hydrophilic segment of the copolymer is a polyalkyl glycol such as polyethylene glycol (PEG). Other examples of suitable compounds for the hydrophilic segment include poly(hydroxyethyl methacrylate), poly(acrylic acid), poly(methacrylic acid), polyacrylamide, poly(sulfobetaine-vinyl pyridine), poly(sulfobetaine-vinylimidazole), poly(carboxybetaine-vinylpyridine), poly(carboxybetaine-vinylimidazole) and polymers of acrylates, methacrylates or acrylamides featuring carboxybetaine, sulfobetaine, phosphorylcholine, or other zwitterionic groups.

### Methods of Making a Segregated Polymeric Material

Another aspect of the invention provides a method of making a segregated polymeric material. The method includes the steps of providing a segregable polymeric mixture comprising a silicon-based hydrophobic polymer and a copolymer comprising a silicon-based hydrophobic polymer and a hydrophilic segment; curing the segregable polymer mixture; and contacting a surface of the segregable polymeric material with an aqueous solution, thereby forming a segregated polymeric material having a hydrophilic layer where the segregable polymeric material was contacted with the aqueous solution and a hydrophobic layer where the segregable polymeric material was not contacted by the aqueous solution.

An important feature of the invention is that it provides a method capable of making a segregated polymeric material without having to apply the polymer and additives in separate steps. The essential steps of the method are therefore just the steps of preparing a segregable polymeric mixture and forming a segregated polymeric material by contacting a portion of the segregable polymeric mixture with an aqueous solution. The curing step is also important, but this step can occur simply by allowing time to pass. Therefore, in some embodiments, the method consists of or consists essentially of only these steps.

The term “segregable,” as used herein, refers to a mixture including at least two different components that has the potential to be segregated into different regions in a final segregated material. For example, a polymer mixture including a hydrophobic polymer and a relatively hydrophilic copolymer in which the mixture forms regions having different hydrophilicity upon exposure to an aqueous solution is a segregable polymer mixture. The method of making a segregated polymeric material described herein involves the steps necessary to convert a segregable polymeric material including the silicon-based hydrophobic polymer and a copolymer comprising a silicon-based hydrophobic polymer and a hydrophilic segment into a segregated polymeric material.

The methods of making a segregated polymeric material can be applied to make any of the segregated polymeric materials described herein. Likewise, any of the amounts and types of polymers and copolymers found in the segregated polymeric material can be included in the initial segregable polymeric material used to make the segregated polymeric material. For example, in some embodiments, the silicon-based hydrophobic polymer used is polydimethylsiloxane (PDMS), while in further embodiments the hydrophilic segment is a polyalkyl glycol such as polyethylene glycol (PEG). In a preferred embodiment, the silicon-based hydrophobic polymer is PDMS, and the copolymer comprises a PDMS-PEG copolymer. In further embodiments, the segregable polymeric material comprises from 0.1% to 5% of the copolymer, while in yet further embodiments the segregable polymeric material comprises from 0.1% to 1.5% of the copolymer.

The mixture of the hydrophilic polymer and the copolymer are formed into a polymeric material by curing the two components together. Curing involves toughening or hardening of a polymer mixture by cross-linking the components (e.g., the PDMS and the PDMS-PEG copolymer). Curing can be accelerated using electron beams, ultraviolet light, heating the mixture, or through the use of chemical additives. Curing can also typically be achieved by simply allowing the mixture to set for a significant period of time, such as 24 hours. Curing agents and methods for curing silicon-based organic polymers are commercially available and are well-known to those skilled in the art.

The cured segregable polymer material is then segregated by contacting the polymer mixture with an aqueous solution. Upon contact with the aqueous solution, the copolymer within the silicon-based organic polymer self-assembles at the water/polymer interface to create a hydrophilic later. Only a portion or side of the cured segregable polmer material should be contacted with the aqueous solution in order for segregation to that portion or side of the polymer material to occur, thereby forming an amphiphilic material. Typically, with a sheet of polymer material, this will occur if the polymer material is placed on a substrate before being contacted with the aqueous solution, such that the side of the polymer material placed on the substrate is shielded from the aqueous solution, while the other side is completely contacted by the aqueous solution. An aqueous solution can be a water solution (e.g., purified or distilled water) or it can be a water-based solution including additional material such as salts (e.g., a buffered solution).

Preferably the cured segregable polymer mixture is contacted with the aqueous mixture for a significant period of time in order to provide time for segregation to occur. For example, in some embodiments, the segregable polymer mixture is contacted with the aqueous solution for 5 to 10 minutes, for 10 to 15 minutes, for 15 to 20 minutes, for 20 to 25 minutes, for 25 to 30 minutes, for 30 to 35 minutes, for 35 to 40 minutes, for 40 to 45 minutes, for 45 to 50 minutes, for 50 to 55 minutes, or for 55 to 60 minutes. In other embodiments, the segregable polymer mixture is contacted with the aqueous mixture for 25 to 45 minutes.

The present invention can be used to create a segregated polymeric material that can be used in place of earlier non-segregated polymeric material to provide a device or material having a modified surface. Accordingly, in some embodiments, the method is used to prepare a segregated polymeric material which manufactured in a useful shape. This shape can be used without further modification, as in the case, for example, of sheets or tubing prepared using the segregated polymeric material. Alternately, the segregated polymeric material can be bonded to another surface after it has been prepared. For example, in some embodiments, the segregated polymeric material is treated with plasma to adhere it to a surface. Alternately, in some embodiments, the segregable polymeric material is used to coat another surface to modify the surface of the material being coated. When used as a coating, the segregable polymeric material is applied to a surface before contacting a surface of the segregable polymeric material with an aqueous solution. When used as a coating, the segregable polymeric mixture can be cured before or after applying it to the surface being coated.

### Kits

In another aspect, the present invention provides kit for modifying a surface. Modifying a surface refers to the ability of the kit to provide a replacement material that has modified characteristics relative to the material being replaced, or for use of the material to coat an existing surface to provide a modified surface. The kit includes a segregable polymeric material, comprising a silicon-based hydrophobic polymer and a copolymer comprising a silicon-based hydrophobic polymer and a hydrophilic segment; and a package for holding the one or more components of the kit. The package may be formed from a variety of materials such as glass or plastic, and should be configured to hold the components of the kit, and is preferably labeled so that its nature can be readily identified. In some embodiments, the kit can further include a mold in which the segregable polymeric material can be cured into a particular shape.

The components of the kit include the segregably polymeric material and any other materials necessary to prepare a segregated polymeric material, such as a curing agent and aqueous solution. The components of the kit can be separately included in containers or vials. The segregable polymeric material can be included in the kit as a mixture of the silicon-based hydrophobic polymer and the copolymer comprising a silicon-based hydrophobic polymer and a hydrophilic segment, or the hydrophobic polymer and the copolymer can be provided in separate containers.

The segregated polymeric materials of the kit can be suitable for preparing any of the segregated polymeric material described herein. Likewise, any of the amounts and types of polymers and copolymers found in the segregated polymeric material can be included in the initial segregable polymeric material used to make the segregated polymeric material. For example, in some embodiments, the silicon-based hydrophobic polymer is polydimethylsiloxane (PDMS), while in further embodiments the hydrophilic segment is a polyalkyl glycol such as polyethylene glycol (PEG). In some embodiments, the segregable polymeric material comprises from 0.1% to 5% of the copolymer, while in other embodiments the segregable polymeric material comprises 0.1% to 1.5% of the copolymer.

In some embodiments, the kit further includes instructions for using the segregable polymeric material to increase the hydrophilicity of a surface. While the instructions are typically written or printed materials they are not limited to such. Any medium capable of storing such instructions and communicating them to an end user is contemplated by this disclosure. Such media include, but are not limited to, electronic storage media (e.g., magnetic discs, tapes, cartridges, chips), optical media (e.g., CD ROM), and the like. As used herein, the term “instructions” can include the address of an internet site that provides the instructions.

### Modified Microfluidic Devices

Another aspect of the invention provides a modified microfluidic device. The microfluidic device is modified to include one or more surfaces that have been modified to include the segregated polymeric material described herein. In one embodiment, the modified microfluidic device comprises a microfluidic device including at least one channel defined by a first substrate positioned over a second substrate; wherein the channel comprises a segregated polymeric material comprising a silicon-based hydrophobic polymer and a copolymer comprising a silicon-based hydrophobic polymer and a hydrophilic segment, wherein the copolymer has been segregated to a surface of the material by contacting the surface with an aqueous solution. One substrate comprises the segregated polymeric material, while the other substrate can be other material such as glass, an unmodified silicon-based hydrophobic polymer such as PDMS, or plastics such as acrylic, polystyrene, polypropylene, polycarbonate, or polymethyl methacrylate.

Microfluidic devices are well known to those skilled in the art. A microfluidic device is a set of micro-channels etched or molded into a material (e.g., PDMS). The micro-channels forming the microfluidic device are connected together in order to achieve the desired features of the device, such as mix, pump, sort, or control for the biochemical environment within the micro-channels. The microfluidic device typically includes a network of micro-channels trapped into the microfluidic device that are connected to the outside by inputs and outputs pierced through the material of the device to serve as an interface between the device and the outside world. Through these input and outputs, the liquids (or gases) are injected and removed from the microfluidic device (through tubing, syringe adapters or even simple holes in the device) with external active systems such as pumps or syringes. In some embodiments, various chemicals or biomolecules (e.g., antigens or antibodies) can be immobilized on regions within the microfluidic device.

A variety of different types of microfluidic devices are known to those skilled in the art. Examples of different types of microfluidic devices include straightforward analytic devices, organs-on-a-chip, gene chips, protein chips, and lab-on-a-chip. In some embodiments, the microfluidic device is a lab-on-a chip. A lab-on-a-chip is a microfluidic device that integrates onto a single chip one or several analyses, which are usually done in a laboratory; analyses such as DNA sequencing and biochemical detection, or chemical synthesis. Lab-on-a-chip microfluidic devices typically require a relatively complex network of channels.

The modified microfluidic device can include any of the segregated polymeric material described herein. Likewise, any of the amounts and types of polymers and copolymers found in the segregated polymeric material can be included in the segregated polymeric material used to make the modified microfluidic device. For example, in some embodiments, the silicon-based hydrophobic polymer is polydimethylsiloxane (PDMS), while in further embodiments the hydrophilic segment is a polyalkyl glycol such as polyethylene glycol (PEG). In yet another embodiment, the silicon-based hydrophobic polymer is PDMS, and the copolymer comprises a PDMS-PEG copolymer. In some embodiments, the segregated polymeric material comprises from 0.1% to 5% of the copolymer, while in other embodiments the segregated polymeric material comprises 0.1% to 1.5% of the copolymer.

In some embodiments, the segregated polymeric material is formed into a microfluidic device; i.e., it is directly used in the manufacture of a microfluidic device. In such cases, the segregable polymer material is cured in a mold having the desired shape of the microfluidic device. In some embodiments, photolithography is used to define the channel in the segregable polymer material. In other embodiments, the segregated polymeric material is applied to an existing microfluidic device in order to modify a particular surface, such as the channel of the device, where improved wettability and/or protein adsorption characteristics are desired. Rapid prototyping of microfluidic systems using PDMS has been described, and these methods can be followed using the segregated polymeric materials described herein. See Duffy et al., Anal. Chem. 70, pp. 4974-4984 (1998).

An example has been included to more clearly describe particular embodiments of the invention. However, there are a wide variety of other embodiments within the scope of the present invention, which should not be limited to the particular example provided herein.

### EXAMPLE

### Simple Surface Modification of Poly(dimethylsiloxane) via Surface Segregating Smart Polymers for Biomicrofluidics

This example demonstrates a useful approach to improve the hydrophilicity of PDMS surfaces by adding a PDMS-PEG block copolymer (BCP) at concentrations between 0.25-2%, during PDMS premixing and before curing. The rest of the device manufacture process is conducted with no further changes, enabling this surface modification approach to be directly plugged into existing protocols. Compared to other additives that have been explored to date the utilization of PDMS-PEG block copolymer provides better compatibility between the additive and PDMS, keeping the device optically clear at concentrations up to 0.25%. These copolymers segregate to the surface when exposed to water/aqueous solutions, which renders the surface hydrophilic, as demonstrated by dynamic water contact angle (WCA) measurements. It also reduces non-specific adsorption of proteins (albumin, lysozyme and immunoglobulin G), as indicated by both fluorescent adsorption experiments on slabs and by quantitative experiments on fabricated microfluidic devices. The PDMS monolith and PDMS segments in BPC interact through van der Waals and hydrophobic interactions that improve the stability of the PEG layer on the PDMS surface. Yu et al., Soft Matter 2, 705-709 (2006) Furthermore, the PDMS chains in the BCP can potentially be cross-linked with the chains of the monolith during the plasma treatment stage, further improving the stability of the hydrophilic surface. Indeed, the inventors show that the hydrophilicity of PDMS modified with this copolymer is retained at least nine months even upon exposure to isopropanol (IPA) soaking and plasma treatment. Mechanical properties and optical clarity of PDMS were also preserved up to 1.0% and 0.25% of PDMS-PEG BCP concentrations respectively. Unlike previous publications, this is first report that the biocompatibility of PDMS with PDMS-PEG BCP were tested by culturing primary rat hepatocytes in glass-(PDMS-PEG BPC modified) PDMS microfluidic tissue culture devices. The modified devices performed just as well as BPC free PDMS devices and presented no adverse effects. These results demonstrate that the addition of this PDMS-PEG BCP to PDMS before the manufacture and curing of biomicrofluidic devices results in a durable increase in hydrophilicity and resistance to non-specific adsorption without sacrificing mechanical properties, optical clarity, or biocompatibility. Therefore, this method promises to be a very simple, rapid, and cost-effective approach to generate hydrophilic and protein repellent PDMS elastomer for microfluidic devices as well as other uses such as tubing and sealants.

### Results and Discussion

Surface Modification of PDMS with PDMS-PEG BCP Additives

As discussed above, PDMS-PEG BCP was selected as the smart copolymer additive for hydrophilizing the PDMS surface. This copolymer, a commercially available surfactant, includes a hydrophobic PDMS segment compatible with the base elastomer (e.g. PDMS) and a hydrophilic, fouling resistant PEG block. The PDMS segment solubilizes the additive within the elastomer matrix during preparation and then anchors the additive in the cured PDMS. It can also be linked with the base PDMS during the plasma treatment used for bonding the device together, improving the longevity of the surface modification. The short chain length and BCP architecture of the additive leads to its segregation to the sample surface. Hutchings et al., Polym. Int. 57, 163-170 (2008) When the sample surface is exposed to water (e.g. when the microfluidic channel is filled with aqueous media), the copolymer self-assembly and self-organizes at the PDMS/water interface to expose the PEG segments to the aqueous solution and create a stable hydrophilic surface that prevents the adsorption of proteins and other bio-macromolecules (FIG. 1) without using any additional steps or changing the manufacturing process.

Hydrophilicity and Wettability of PDMS with PDMS-PEG BCP Additives

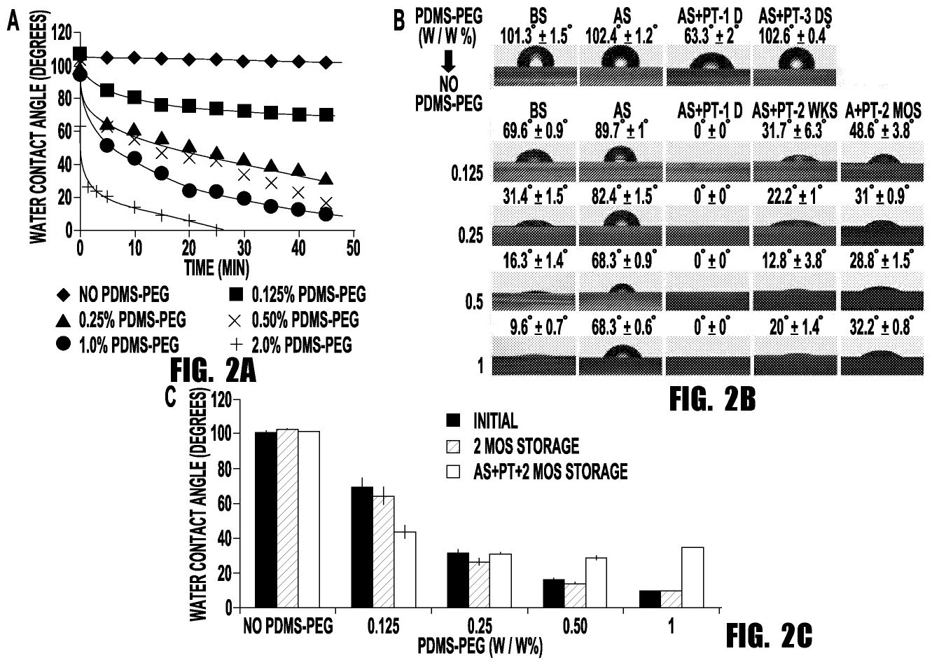

To test the hypothesis that the PDMS-PEG BCP would lead to an increased hydrophilicity stable over long time scales, sessile water droplet contact angles (WCA) were measured on PDMS-PEG modified PDMS surfaces and compared to the BPC free PDMS over a 9-month duration. Dynamic contact angle measurements were used, which were reported as a useful tool to evaluate wettability of modified PDMS surfaces in the literature. Seo, J. & Lee, L. P., Sensor Actuat B Chem 119, 192-198 (2006) FIG. 2a shows the variation of the WCA of PDMS samples prepared with varying amounts of PDMS-PEG BPC additive in time. The initial contact angles of all samples except the one containing 2% PDMS-PEG additive were quite high, between 94-106°. This indicates that in air, the sample surface is mostly covered with hydrophobic PDMS segments. However, while the WCA of PDMS with no PDMS-PEG BPC remained steady above 101° during the 45-minute experiments, the WCA of all PDMS with PDMS-PEG BCP additives decreased in time. Furthermore, this decrease was generally proportional with the concentration of PDMS-PEG BPC additives. After a 45-minute exposure to water, the PDMS-PEG BPC additive containing sample surfaces became significantly more hydrophilic than PDMS with no PDMS-PEG BCP. As little as 0.125% PDMS-PEG BPC led to a final contact angle of 69.6°, comparable with the lowest contact angles reported for other additive-modified PDMS systems. Zhou et al., Anal Chem 81, 6627-6632 (2009). The final contact angle for the sample with 1% PDMS-PEG BPC was only 9.6° , whereas samples with 1.5% and 2% PDMS-PEG BPC were fully wetted (WCA≈0°) by 45 minutes and 25 minutes, respectively. Nevertheless, it is important to note that increasing BCP concentration for reducing hydrophobicity is not the only requirement for a successful and stable surface modification. Bonding problems were encountered on glass slides during oxygen plasma treatment at higher copolymer concentrations (1.5 and 2 (w/w %)). Therefore, these concentrations were eliminated from further experiments.

These results confirm that upon exposure to water, the PDMS-PEG BPC self-assembles at the interface to create a hydrophilic PEG layer, and indicate that this rearrangement occurs faster and more effectively with increasing PDMS-PEG BPC content. Furthermore, it shows final WCA values much below previous reports for additive-modified PDMS materials. However, in practical applications, PDMS is not used directly after molding. PDMS devices are typically sterilized by immersion into an alcohol such as IPA which may leach out additives. Then, they are treated with O₂ plasma and bonded to glass, a silicon wafer, or another piece of PDMS.

It is critical for the improved surface hydrophilicity to be stable during these processing steps. Furthermore, microfluidic devices are not necessarily used directly after manufacture. Therefore, the modified surface needs to be stable over long time periods. To test these parameters, the inventors first decided the soaking time of PDMS with and without PDMS-PEG BPC additives. The WCA of PDMS was measured without PDMS-PEG BPC and PDMS with 0.5% PDMS-PEG BPC after soaking in IPA for 6, 12 and 24 hours. Upon soaking in IPA, the WCA of PDMS with no PDMS-PEG BPC did not change significantly. In contrast, the WCA of PDMS with 0.5% PDMS-PEG BPC additives increased drastically for all immersion time periods. The hydrophilicity of samples after 6 hour IPA soaking was higher as compared to 12 hour and 24 hour immersion. It appears that during IPA soaking, the lower molar mass fraction of PDMS-PEG BPC diffused out into IPA. This resulted in a decrease in copolymer concentration in the PDMS and a significant increase in the contact angle. It appeared that 12 hour IPA soaking was enough time to remove all the lower mass fraction of BPC since no significant change in hydrophilicity was observed between 12 hour and 24 hour. However, some PDMS-PEG BPC remained in the PDMS, as the final contact angles were still much lower than that of PDMS with no PDMS-PEG BPC. The remaining PDMS-PEG BPC were likely the higher molar mass fractions, which improved the long-term stability of the layer. Furthermore, this decreased the risk of the additive leaching out of the PDMS during operation, which could negatively impact biocompatibility. Nonetheless 24 hour IPA soaking was selected for further experiments.

The WCA of PDMS with PDMS-PEG BPC additives was examined after soaking them in IPA for 24 hours and the treating them with O2 plasma (FIG. 2b). A day after O₂ plasma treatment, the hydrophobicity of both PDMS with and without PDMS-PEG BPC was significantly reduced (FIG. 2B). The WCA of PDMS with no PDMS-PEG BPC became 63.3°. It has previously been reported that PDMS surface exposed to plasma had increased oxygen content and possibly silicon (Si) atoms are bonded to three or four oxygen atoms which reduces hydrophobicity. Hettlich et al., Biomaterials 12, 521-524 (1991) The main challenge posed by the plasma oxidation is the eventual hydrophobic recovery. This is a result of the reorientation of pre-existing oligomers from the bulk to the surface. Chen, I. J. & Lindner, E., Langmuir 23, 3118-3122 (2007). Indeed, 3 days after plasma treatment, the WCA of the PDMS with no PDMS-PEG BPC additive returned to its initial value of 102°. PDMS with PDMS-PEG BPC additives also exhibited an increase in hydrophilicity upon O₂ plasma treatment. The surfaces became fully wettable a day after plasma treatment with WCA values around 0°. As seen in FIG. 2B, although a minor increase in wettability was observed, all PDMS with PDMS-PEG BPC still kept their hydrophilicity, with WCA values between 48.6°±6.6° and 28.8°±2.7°. These values are significantly lower than previous reports. We believe that the existence of PEG on modified PDMS surface enhances Si—O bonding and as a result, more SiOx rich layer and more hydrophilic surfaces can be obtained as compared to PDMS with no PDMS-PEG BPC. Importantly, this enhanced surface hydrophilicity was stable for at least nine months. The increased surface hydrophilicity may have enhanced the surface segregation of the PDMS-PEG BPC by creating a local gradient, drawing the copolymer to the surface even before exposure to water. Furthermore, the plasma treatment can create bonds between different PDMS segments, chemically linking the PDMS-PEG BPC additive to the PDMS network. This may anchor the PDMS-PEG BPC specifically on the top surface of the sample, improving the longevity of surface modification. It was also observed that PDMS with PDMS-PEG BPC additives can be shelved for 9 months with or without plasma treatment (FIG. 2c) and with or without soaking in IPA without losing their hydrophilicity.

Characterization of the Physical Properties of PDMS with PDMS-PEG BCP Additives

### Transparency

Given that microfluidic devices are commonly used together with bright field and fluorescence microscopy for imaging cells (Ge et al., Cytometry A 83A, 552-560 (2013)), transparency of substrates, PDMS and alternatives, used in those devices is one of the most critical properties. Since blue light [460-500 nm] commonly used to image green fluorescent protein (GFP) and Calcein AM, and green light [528-553 nm], useful for imaging red fluorophores we assessed the optical clarity of PDMS with and w/o PDMS-PEG BPC additives by measuring light transmittance through 8 mm thick slabs between 400-600 nm wavelengths in the UV-visible range before and after an IPA soak. Also the transmittance values of the center wavelengths of blue light (480 nm) and green light (540 nm) were given in Table 1 for PDMS with and w/o PDMS-PEG BPC. Before soaking in IPA, transparency values of PDMS with PDMS-PEG BPC up to 0.5% additive concentration are comparable to PDMS with no PDMS-PEG BPC, with all transmittance values above 96%. The transparency of the PDMS with 1% PDMS-PEG is slightly lower, with transmittance values in the 80%-93% range. This may arise from the formation of micelles or similar aggregates of the PDMS-PEG BPC surfactant in PDMS at these higher concentrations, as observed in other studies. After soaking in IPA, samples modified with 0.125% and 0.25% PDMS-PEG BPC additives exhibit approximately the same clarity with unmodified PDMS. However, the optical clarity of PDMS with 0.5% and 1% PDMS-PEG BPC concentrations decreased, with transmittance values around 75% and 50%, respectively. This may arise from the IPA soak removing the lower molar mass PDMS-PEG chains, and enabling the higher molar mass chains to cluster into micelles. Alternatively, the IPA soak may have led to an increase in surface roughness that leads to light scattering.

TABLE 1
Mechanical and optical properties of PDMS with PDMS-PEG BCP additives

| | | Compressive | Transmittance | Transmittance |
|---|---|---|---|---|
| (PDMS-PEG) | Young's | Modulus | (%) | (%) |
| (w/w %) | Modulus (MPa) | (MPa) | BS/AS (480 nm) | BS/AS (540 nm) |
| No PDMS-PEG^{a} | 1.32 ± 0.07 | 186.9 ± 5.39 | 100 ± 0/100 ± 0 | 100 ± 0/100 ± 0 |
| No PDMS-PEG | 1.23 ± 0.08 | 217 ± 3.4 | 100 ± 0/100 ± 0 | 100 ± 0/100 ± 0 |
| 0.125 | 1.32 ± 0.03 | 218 ± 3.2 | 100 ± 0/100 ± 0 | 100 ± 0/100 ± 0 |
| 0.25 | 1.38 ± 0.02 | 203 ± 5.3 | 100 ± 0/99 ± 0 | 100 ± 0/99 ± 0 |
| 0.5 | 1.26 ± 0.02 | 201 ± 8.1 | 97 ± 0/78 ± 0 | 98 ± 0/76 ± 0 |
| 1.0 | 1.17 ± 0.1 | 219 ± 1.2 | 84 ± 0/57 ± 0 | 87 ± 0/55 ± 0 |

^{a}Young's modulus and compressive modulus of PDMS with no PDMS-PEG BPC from literature⁴⁴
BS: Before IPA Soaking,
AS: After IPA Soaking.
The data are shown as the mean ± SD (n = 3).

### Surface Characterization

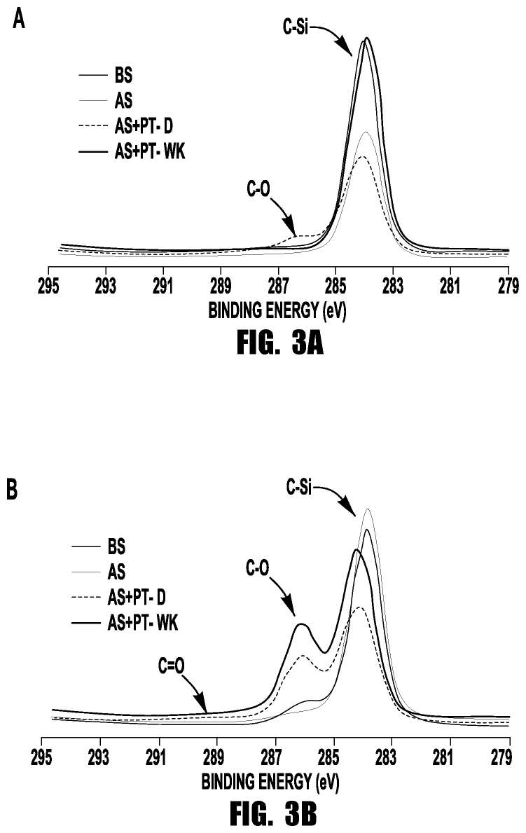

X-ray photoelectron spectroscopy (XPS) was used to gain a better understanding of the surface chemistry of PDMS with no PDMS-PEG BPC and PDMS with 0.25% PDMS-PEG BPC at each stage of the microfluidic device manufacture process. The elemental surface compositions of both the PDMS with no PDMS-PEG BPC and 0.25% PDMS-PEG BPC determined by the survey scan, remained essentially unchanged after soaking in IPA After plasma treatment, survey scans of PDMS with and without PDMS-PEG BPC additives highlight the changes in elemental composition, namely the increase in carbon and oxygen content and a corresponding decrease in silicon. High-resolution scans of C1 s spectra were used to gain deeper insight into the chemical changes that occurred during these processes (FIG. 3(a-b)). PDMS with no PDMS-PEG spectra featured only one peak, at 284.2 eV, corresponding to C—Si bonds. This was unchanged upon soaking in IPA. Upon plasma treatment, peaks appeared at 286.3 eV and 289.1 eV, assigned to C—O and C—O bonds, respectively. Sharma et al., Vacuum 81, 1094-1100 (2007) These peaks, however, completely disappeared after a week. This is due to the recovery of hydrophobicity after oxidation by reorientation of the surface silanol groups into the bulk polymer, which provides for the movement of free PDMS chains from the bulk phase to the surface and condensation of silanol groups at the surface. Gokaltun et al., Technology (Singap World Sci) 5, 1-12 (2017) In contrast, PDMS with 0.25% PDMS-PEG BPC showed both a strong peak near 284.6 eV arising from C-Si bonds, and a shoulder near 286.3 eV, corresponding to C—O bonds. Upon plasma treatment, the intensity of the C—O peak increased, and a new peak corresponding to C═O appeared. Unlike BPC free PDMS, the intensity of the C—O and C═O peaks in the PDMS with 0.25% PDMS-PEG remained unchanged a week after plasma treatment. This phenomenon confirms the existence of PEG molecules on the modified surface for long-term stability after plasma treatment, which is in good agreement with the hydrophilicity data (FIG. 2b).

### Mechanical Properties

PDMS is a good candidate in microfluidics design due to its high compliance and flexiblity. Its Young's modulus depends on the exact formulation, and is around ˜1.32-2.12 MPa for the commonly used pre-polymer to curing agent ratio of 10:1. Wu et al., J Am Chem Soc 129, 7226-7227 (2007). Ideally, any surface modification approach should not compromise these mechanical properties. To check the mechanical properties of PDMS with PDMS-PEG BPC additives, tensile strength and compressive modulus were evaluated by dynamic mechanical analysis (DMA). The Young's modulus and compressive modulus of the modified samples were calculated for the linear elastic region (<40% strain) using Hooke's law (Table 1). No significant change was observed with the mechanical properties of the modified PDMS when compared with literature studies.

### Biocompatibility

In most microfluidic applications, the materials that form the device are in contact with cells. Therefore, when designing a new material for biomicrofluidics, it is crucial to take its interactions with cells into account. For instance, surface modifying additives may leach from the device into the microfluidic channel and affect cell viability and/or function. This may lead to poor device performance even if surface hydrophilicity is enhanced. To date, there are some studies that evaluated the biocompatibility or cell adhesion of modified PDMS microfluidic devices or slabs using mammalian A549 cells (Chang et al., Lab Chip 14, 3762-3772 (2014)), L929 mouse fibroblasts (Seo et al., Biomaterials 30, 5330-5340 (2009)), tendon stem cells (Li, et al., J Biomed Mater Res A 106, 408-418 (2018)), mesenchymal stem cells (MSCs) (Kuddannaya et al., ACS Appl Mater Interfaces 5, 9777-9784 (2013)), brain cerebral cortex cells (Kuddannaya et al., ACS Appl Mater Interfaces 7, 25529-25538 (2015)), HeLa cells (Wu et al., Colloids Surf B Biointerfaces 116, 700-706 (2014).) and stroma cells. Zhang et al., Biomicrofluidics 5, 32007-3200710 (2011) However, none of the previous PDMS-modification strategies were evaluated for compatibility with hepatocytes, the parenchymal cells of the liver, which are highly susceptible to adverse reactions. Liver plays a central role in drug metabolism and detoxification so the development of liver-on-a-chip models for successful prediction of toxic response become the most promising technology nowadays. Given the overwhelming importance of liver in drug toxicity and efficacy studies via in vitro models, including the recent liver-on-chip devices, rat primary hepatocytes were used to test the biocompatibility of our modified PDMS substrate in a microfluidic format.

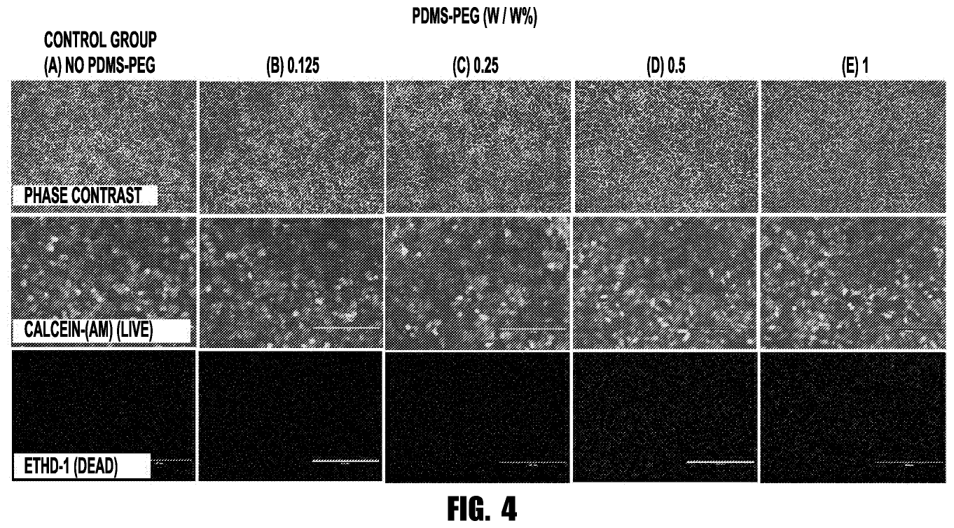

To ensure that the use of the PDMS-PEG in microfluidic device manufacture did not adversely impact cell function, microfluidic devices were manufactured using a glass bottom and PDMS top with or without PDMS-PEG BPC additives, and cultured primary rat hepatocytes in these devices. In order to quantitatively evaluate cell viability, the cells were stained with a live (green)/dead (red) stain 3 days after the culture (FIG. 4). Cells had a high viability (>99.0%) throughout the 3 day culture period following the initial cell seeding into the microdevice. The use of the PDMS-PEG BPC additive led to no visible or significant differences in cell viability or morphology. PDMS-PEG BPC modified microfluidic devices performed just as well as PDMS with no PDMS-PEG additives and presented no adverse effects. Since in vitro systems are often preferred as models to predict drug toxicity and pharmacokinetics for clinical cases, this design can be easily scaled to create an array of in vitro studies for rapid drug development or studying toxicity of drugs due to the simplicity of the device.

Protein Adsorption on PDMS with PDMS-PEG BPC Additives

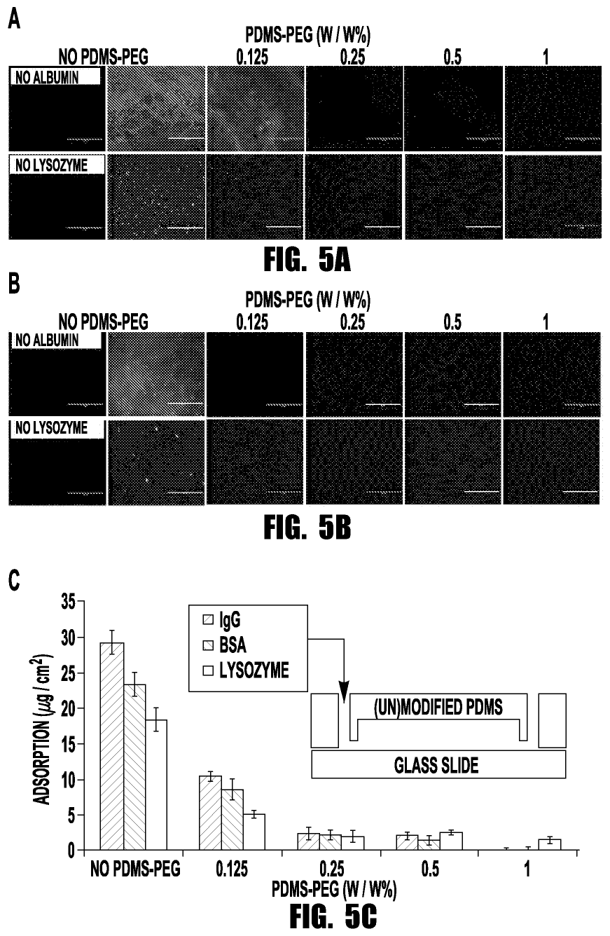

The main goal of developing this PDMS surface modification approach was to create a non-biofouling surface and prevent the non-specific adsorption of proteins onto the microfluidic device. This is motivated by two phenomena. First, most of the undesired bioreactions and bioresponses in artificial materials are promoted due to adsorbed proteins. Brash, J. L. & Horbett, T. A. Proteins at Interfaces: Physicochemical and Biochemical Studies. In: ACS symposium series, Washington, D.C.: American Chemical Society 343 (1987) Second, many applications of biomicrofluidics involves controlling the exposure of cells to a known concentration of a specific, desired protein such as a biologic drug. Non-specific adsorption leads to the loss of this drug through adsorption, exposing the cells to a lower concentration than presumed. This can lead to a severe under-estimation of the toxicity and activity of such drugs. While hydrophilicity is broadly correlated with decreased protein adsorption, the relationship is not necessarily straightforward. Therefore, the adsorption of two fluorescently-labeled proteins, albumin and lysozyme, on PDMS slabs was quantitatively measured with and without PDMS-PEG-BPC additives (FIG. 5(a-b)), both directly upon manufacture and following processes that simulate biomicrofluidic device manufacture (IPA soak and 1 week after O₂ plasma treatment). The PDMS with no PDMS-PEG BPC adsorbed significantly more protein than all PDMS with PDMS-PEG-BPC additives, confirming that this approach led to decreased non-specific adsorption. However, PDMS with 0.125% PDMS-PEG exhibited some protein adsorption, whereas no adsorption was visible for any of the other samples. Following soaking in IPA and O₂ plasma treatment, PDMS slabs with PDMS-PEG BPC additives indicated substantially reduced adsorption as compared to PDMS-PEG BPC free PDMS.

To further quantify protein adsorption in a more realistic setting, microfluidic devices were manufactured from PDMS with or without PDMS-PEG BPC additives. A protein solution containing 0.05 mg/mL BSA, lysozyme or IgG was then introduced into the microchannel (30-90 min), and the loss of protein due to adsorption on the device was measured by micro-BCA analysis (FIG. 5c). Devices with PDMS-PEG additives, adsorbed significantly lower quantities of each protein as compared to PDMS with no PDMS-PEG (FIG. 5c). As the BPC concentration increased in the mixture, the level of adsorbed protein decreased. PDMS-PEG BPC additives significantly reduced protein adsorption at concentrations as low as 0.25% (w/w). The use of only 1% PDMS-PEG additive led to 98.9%, 89.4%, and 99.6% lower adsorption of albumin, lysozyme and IgG, respectively when compared to PDMS without PDMS-PEG BPC. Even, an additive concentration of 0.25% PDMS-PEG led to a ˜90% the reduction in protein adsorption. The lowest protein adsorption (97% fibrinogen reduction) reported in the literature was reported using zwitterionic poly(carboxybetaine) (PBC) based triblock copolymer via “graft to” method on PDMS surface. Although polymer grafting is a potent approach to create a non-biofouling layer, it is limited low surface density of grafted chains due to steric interactions between polymer coils. This results in decrease surface homogeneity and uniformity. In addition, this modification method is laborious and lengthy process which is prohibitive for large scale applications. It is very challenging to achieve ultra-low fouling with a simple and robust approach which is critical for many biomedical applications, such as drug toxicity studies, medical implants and drug delivery carriers.

The results were evaluated to make a choice for the optimum PDMS-PEG BPC concentration. As the biocompatibility and mechanical properties of all PDMS with PDMS-PEG BPC additives are almost identical with PDMS without PDMS-PEG BPC, the inventors compared the results of transparency, WCA after plasma treatment (t=45 min) and protein (IgG as a sample protein) adsorption data. They selected 0.25% PDMS-PEG BPC concentration (WCA=31°±0.9°, transmittance=99%, reduction in IgG adsorption relative to PDMS with no additive=92.2%) as the optimum value since the transparency of the modified samples decreased down to 73%, 53% with BPC concentrations of 0.5% and 1% respectively, and the WCA and IgG adsorption values were lower than 0.125% (w/w).

Self-Driven Microfluidic Devices with PDMS-PEG BPC Additives

Having demonstrated the successful hydrophilization of PDMS with PDMS-PEG BPC additives, we investigated the flow characteristic of PDMS with and without PDMS-PEG BPC additives (0.25% and 0.5%) in the capillary microchannels which were bonded on the glass substrates. Two linear channels (height: 0.1 mm, length: 40 mm) with different widths (0.25 mm and 0.5 mm) were tested for self-driven flow experiments. PDMS with no PDMS-PEG BPC were utilized as a control. All samples were tested 3 days after plasma treatment. Liquid was introduced into the inlet of the capillary channel and fluid flow through the channel was recorded by a camera. Table 2 shows the variation of flow velocities of liquid using PDMS samples with varying amounts of PDMS-PEG BPC. All modified devices were shown to fill through steady capillary action, while PDMS without PDMS-PEG BPC failed to fill with liquid. Since the WCA of PDMS with 0.25% and 0.5% PDMS-PEG BPC were very close to each other, a significant difference in capillary flow rates of the modified samples was not observed. The flow rates of the liquid were increased with increasing channel width using PDMS with 0.25% and 0.5% PDMS-PEG BPC. These results show that the capillary flow rate can be altered by changing the dimensions of hydrophilic PDMS microfluidic devices fabricated via surface segregating smart copolymers. The advantage of the fabrication technique presented here is that hydrophilic PDMS microfluidic channels can be obtained with a simple, one step method through inexpensive bench-top methods.

TABLE 2
Capillary-driven flow of hydrophilic PDMS
channels with aqueous solutions

| PDMS-PEG | Flow rate | Flow rate |
|---|---|---|
| (w/w %) | (nL/s)^{a} | (nL/s)^{b} |
| No PDMS-PEG | No flow | No flow |
| 0.25 | 69 ± 2.5 | 181 ± 2 |
| 0.5 | 69 ± 1.5 | 200 ± 1 |

^{a}Channel width = 0.25 mm
^{b}Channel width = 0.5 mm.
The data are shown as the mean ± SD (n = 2).

### Outlook

This example introduces a simple approach to address non-specific protein adsorption, a key problem encountered in the use of PDMS in biomicrofluidic applications, without making any changes to the existing workflow for manufacturing such devices. This method involves simply adding a PDMS-PEG BPC additive to PDMS during device manufacture. This copolymer surface segregates during device manufacture and rearranges to create a hydrophilic surface upon exposure to aqueous media. As little as 0.25% additive leads to contact angles as low as 31.4±1.5 upon exposure to water, whereas 1% additive leads to a fully wettable (WCA≈0) surface. Surface hydrophilicity is retained through common processes used in microfluidic device manufacture (e.g. immersion in IPA and plasma treatment), and after prolonged storage at the bench top for at least 9 months. Only 0.25% PDMS-PEG additive leads to ˜90% reduction in the adsorption of three proteins, whereas 1% additive led to 89-99.6% reduction in protein adsorption. Furthermore, devices prepared with this approach preserve their transparency, flexibility, and biocompatibility with primary rat hepatocytes. According to all results, 0.25% (w/w) copolymer concentration was selected as an optimum value.

The PDMS modification method introduced here does not require any additional steps or equipment for device fabrication. This allows easy adoption and scale-up and is more compatible with mass production of microfluidic devices compared to silicon, glass or thermoplastic alternatives. This method has a potential for applications including drug-related studies, analytical separations, biosensing, cell targeting, and isolation. Apart from the applications in microfluidics, we expect our invention remove barriers that currently prevent the use of PDMS in critical commercial applications such as those in applications in pharmaceutical and biomedical industries.

### Methods

### Microfluidic Device Fabrication for Cell Culture Studies and Protein Adsorption Experiments

Silicon wafer templates served as negative molds to fabricate microfluidic devices using PDMS, (Sylgard 184, Dow Corning, Tewksbury, Mass.) with and without PDMS-PEG BPC additives and utilizing standard soft lithography protocols. McDonald et al., Analytical chemistry 74, 1537-1545 (2002) The microfluidic platform consisted of media fluid inlet/outlet and cell inlet/outlet in the same place, and a cell culture chamber. The dimensions of the chamber were 11 mm²×0.1 mm (Surface area×height). Inlet and outlet ports of the device were punched into the PDMS microfluidic device using a 1.5 mm biopsy punch piercing tool (Ted Pella Inc.). The face of the PDMS with microchannel and a glass microscope slides (75×25 mm, Thermo scientific) were bonded with O₂ plasma (80 W, 35 sec) using a vacuum plasma cleaner.

### Self-Driven Microfluidic Device Fabrication

Self driven microfluidic devices were fabricated with and without PDMS-PEG BPC using replica molding on silicon wafer templates as discussed above. Two linear microfluidic channel designs consisted of media fluid inlet/outlet were fabricated with varied geometries (0.25 mm, 0.5 mm widths, 0.1 mm height, and 40 mm length). Inlet and outlet ports of the microfluidic devices were punched using a 3.5 mm biopsy punch piercing tool (Ted Pella Inc.) and they bonded glass microscope slides (75×25 mm, Thermo scientific) using a O₂ plasma cleaner (80 W, 35 sec). The inventors utilized DDI water with food color during the experiments and recorded videos to calculate the experimental capillary flow rates.

Production of PDMS with PDMS-PEG BPC Additives

A block copolymer with a poly(dimethylsiloxane) (PDMS) and hydrophilic poly(ethylene glycol) (PEG) blocks, PDMS-PEG, was purchased from Gelest (dimethylsiloxane-(60-70% ethylene oxide) block copolymer, MW 600, Gelest, USA) and utilized as an additive in the modification of microfluidic devices. Silicone pre-polymer and curing agent were mixed in a mass ratio of 1:10 (w/w). Desired amount of PDMS-PEG BPC was then added to the polymer base-curing agent mix to obtain a final additive concentration of 0.125%, 0.25%, 0.5% 1.0%, 1.5%, 2.0% (w/w) in the mixtures. The mixtures were blended using a glass a rod and poured onto a silicon wafer or into a petri dish for the fabrication of microfluidic devices and slabs, respectively. Trapped air bubbles were removed by keeping the mixture at +4 ° C. for 15 min. After removing air bubbles, the blended mixture was cured at 70 ° C. for 24 h. All devices and slabs (˜2 mm thick) were rinsed with isopropyl alcohol (IPA) for 24 h and dried at room temperature (RT). Steam sterilization was applied to microfluidic devices before performing experiments.

### Primary Rat Hepatocyte Isolation and Cell Seeding

For culturing primary rat hepatocytes, cryopreserved primary rat hepatocytes were obtained through the Triangle Research Lab or Massachusetts General Hospital. The cells were thawed in rat hepatocyte thawing medium according to the manufacturer's protocol. In general, as determined by trypan blue exclusion, 100-150 million hepatocytes with 80-95% cell viability after thawing the cells were obtained and a suspension consisting of primary rat hepatocytes at a final concentration of 5 million cells (M) mL-1 was prepared. Before introducing rat hepatocytes, glass bottom of the microfluidic devices were coated with 50 μg/mL fibronectin (Sigma-Aldrich) for 30-45 min at 37° C. in 5% CO₂. Then the cells were plated into the cell culture chamber and the device was connected to a syringe pump with a flow rate of 10 μl/hr and incubated at 37° C. in 5% CO₂. After 24 hours of seeding, the flow of the fresh media was replaced in the cell culture chamber of perfusion devices and continued thereafter. For all fluidic connections and media perfusion, Tygon tubing (0.01″ ID×0.03″ OD, Cole Parmer) was used.

### Hepatocyte Morphology and Cell Viability

Hepatocyte morphology and viability were assessed by phase contrast microscopy (Evos FL Imaging System, ThermoFisher Scientific). Live/Dead Cell Viability/Cytotoxicity Kit (Thermo Fisher Scientific) were utilized to determine the cell viability. For this purpose, Live/Dead assay reagents (calcein AM (10 μL), ethidium homodimer-1 (100 μL)) and PBS (2.5 mL) were combined and vortexed to ensure thorough mixing. Reagents were introduced into the culture chamber and after 30 min incubation (37° C.) and PBS rinsing, images were captured on a EVOS fluorescence microscope to evaluate the cell viability.

### Protein Adsorption Study

PDMS-PEG BPC at ratios between 0.125-1.0 (w/w %) was blended with PDMS and poured into a petri dish and cured at 70° C. for 24 h, as described. After polymerization, round swatches of PDMS samples cut into cylinders (5 mm Dia×4 mm) using a 5 mm dermal punch (Ted Pella Inc.). These samples were immersed in phosphate buffer saline (PBS, pH 7.4) for 2 h to reach pre-equilibration. 0.5 mg/mL solutions of each fluorescently labeled proteins including bovine serum albumin (BSA) (Alexa Fluor 594-labeled BSA, Thermo Fisher Scientific) and lysozyme (FITC-labeled, Nanocs) were dissolved in PBS separately. To study protein adsorption, 50 μL of fluorescently labeled protein solution was placed on the modified PDMS cylinders and incubated in the dark at 37° C. for 1.5 h following rinsing with 200 μL PBS. For comparison, the same procedure was followed for PDMS with no PDMS-PEG BPC substrates. After 1.5 h, all samples were rinsed with PBS and the fluorescent microscope images were captured by Evos FL Imaging System (ThermoFisher Scientific) using 10× objective. Quantitative protein adsorption experiments were also performed using PDMS microfluidic devices with/without PDMS-PEG additives. For this purpose microfluidic devices were conditioned with PBS at a flow rate of 20 μL/min for 4 hours using a syringe pump and emptied prior to the experiment. 0.05 mg/mL solutions of BSA from the chicken egg (Sigma Aldrich), lysozyme from chicken egg white (Sigma Aldrich) and Immunoglobulin G from human serum (IgG) (Sigma Aldrich) were introduced into the device (30-90 min). The amount of adsorbed BSA, lysozyme and IgG were measured comparing the influx and efflux concentrations utilizing the Pierce BCA Protein Assay Kit (Thermo Scientific) according to manufacturer's protocol.

### Characterization

### Mechanical Properties

Mechanical properties (Young's modulus, compressive modulus) were tested using TA Instruments RSAIII Dynamic Mechanical Analyzer (DMA), (Rheometrics Solids Analyzer). PDMS samples with/without PDMS-PEG additives for tensile and compressive testing were fabricated according to ASTM standards.

### Optical Properties

Optical clarity was quantified using UV-Vis spectrophotometer (Thermo Scientific, Genesys 10S equipped with a high-intensity xenon lamp and dual-beam optical geometry) within the wavelength range of 400 nm-600 nm both for PDMS and PDMS-PEG BPC modified PDMS samples (0.125%-1.0% (w/w)). Samples were tested before and after IPA soaking. All samples were prepared with similar thicknesses (˜8 mm) with the purpose of avoiding any disparity in the data.

### Surface Characterization:

Sessile drop water droplet contact angles (WCA) were measured at the polymer-air interface using contact angle goniometer (Rame-Hart Instrument Co., Netcong, N.J.) to assess the wettability of PDMS modified with PDMS-PEG BPC additives. Briefly, 6 μL volume of distilled water (18.2 MΩ cm⁻¹ water) was dropped onto the BPC modified PDMS slab (2 cm×2 cm) and static contact angle measurements were measured at regular time intervals to observe the timeline of surface arrangement. WCA of PDMS without BPC additive substrates (2 cm×2 cm) was also measured as controls. To characterize the surface chemistry of PDMS with and without PDMS-PEG BPC additives, square samples (1 cm×1 cm) were prepared for X-ray photoelectron spectroscopy (XPS) measurements. It was completed on the K-Alpha+ XPS system from Thermo Scientific at Harvard University's Center for Nanoscale Systems. The probe for the measurement was aluminum k-a X-ray line with energy at 1.4866 keV and X-ray spot size at 400 um with 90 degrees take-off angle (sampling depth is around 10 nm from the surface). Flood gun, which supplies low energy electron and ion were used throughout the entire experiment for sample surface charge compensation. Both survey spectrum and high-resolution scan data were collected at each sample. For survey spectrum, the scan was completed by taking an average of 5 scans in 1 eV steps with passing energy at 200 eV from −10 eV to 1350 eV binding energy. For high resolution scans, the data were collected by taking an average of 10 scans in 0.1 eV steps with passing energy at 50 eV for Si 2p, O 1s, and C 1s photoelectron lines.

### Statistical Analysis

Each experiment was conducted in triplicates from at least three different rat isolations. Three different samples were utilized to quantify the WCA, optical clarity, protein adsorption, and mechanical analysis measurements (n=3). Capillary driven experiments were performed with two different samples (n=2). XPS of each sample were obtained by taking and average of 5 and 10 scans for survey spectrum and high resolution scan data respectively.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A segregated polymeric material, comprising a silicon-based hydrophobic polymer and a copolymer comprising a silicon-based hydrophobic polymer segment and a hydrophilic segment, wherein the copolymer has been segregated to a surface of the material by contacting the surface with an aqueous solution.

2. The segregated polymeric material of claim 1, wherein the silicon-based hydrophobic polymer is polydimethylsiloxane (PDMS).

3. The segregated polymeric material of claim 1, wherein the hydrophilic segment is a polyalkyl glycol.

4. The segregated polymeric material of claim 4, wherein the polyalkyl glycol is polyethylene glycol (PEG).

5. The segregated polymeric material of claim 1, wherein the silicon-based hydrophobic polymer is PDMS, and the copolymer comprises a PDMS-PEG copolymer.

6. The segregated polymeric material of claim 1, wherein the material comprises from 0.1% to 5% of the copolymer.

7. The segregated polymeric material of claim 1, wherein the material comprises from 0.1% to 1.5% of the copolymer.

8. The segregated polymeric material of claim 1, wherein the material is transparent.

9. The segregated polymeric material of claim 1, wherein a segregated hydrophilic layer of the segregated polymeric material has a contact angle of 40% or less.

10. The segregated polymeric material of claim 1, wherein a hydrophilic layer of the segregated polymeric material adsorbs at least 80% less protein compared with a surface consisting of the silicon-based hydrophobic polymer.

11. A method of making a segregated polymeric material, comprising the steps of providing a segregable polymeric mixture comprising a silicon-based hydrophobic polymer and a copolymer comprising a silicon-based hydrophobic polymer segment and a hydrophilic segment, curing the segregable polymer mixture, and contacting a surface of the segregable polymeric material with an aqueous solution, thereby forming a segregated polymeric material having a hydrophilic layer where the segregable polymeric material was contacted with the aqueous solution and a hydrophobic layer where the segregable polymeric material was not contacted by the aqueous solution.

12. The method of claim 11, wherein the silicon-based hydrophobic polymer is polydimethylsiloxane (PDMS).

13. The method of claim 11, wherein the hydrophilic segment is a polyalkyl glycol.

14. The method of claim 13, wherein the polyalkyl glycol is polyethylene glycol (PEG).

15. The method of claim 11, wherein the silicon-based hydrophobic polymer is PDMS, and the copolymer comprises a PDMS-PEG copolymer.

16. The method of claim 11, wherein the segregable polymeric material comprises from 0.1% to 5% of the copolymer.

17. The method of claim 11, wherein the segregable polymeric material comprises from 0.1% to 1.5% of the copolymer.

18. The method of claim 11, wherein the segregated polymeric material is formed into a microfluidic device.

19. The method of claim 11, wherein the segregable polymeric material is applied to a surface before contacting a surface of the segregable polymeric material with an aqueous solution.

20. The method of claim 11, wherein the segregated polymeric material is treated with plasma to adhere it to a surface.

21. A kit for modifying a surface, comprising a segregable polymeric material, comprising a silicon-based hydrophobic polymer and a copolymer comprising a silicon-based hydrophobic polymer segment and a hydrophilic segment; the hydrophilic segment is a polyalkyl glycol; and the segregable polymeric material comprises from 0.1% to 5% of the copolymer, and a package for holding the one or more components of the kit.

22. The kit of claim 21, wherein the silicon-based hydrophobic polymer is polydimethylsiloxane (PDMS).

23. The kit of claim 21, wherein the hydrophilic segment is polyethylene glycol (PEG).

24. The kit of claim 21, wherein the segregable polymeric material comprises 0.1% to 1.5% of the copolymer.

25. The kit of claim 21, wherein the kit further comprises instructions for using the segregable polymeric material to increase the hydrophilicity of a surface.

26. A modified microfluidic device, comprising
a microfluidic device including at least one channel defined by a first substrate positioned over a second substrate; wherein the channel comprises a segregated polymeric material comprising a silicon-based hydrophobic polymer and a copolymer comprising a silicon-based hydrophobic polymer segment and a hydrophilic segment, wherein the copolymer has been segregated to a surface of the material by contacting the surface with an aqueous solution.

27. The microfluidic device of claim 26, wherein the microfluidic device is a lab-on-a chip.

28. The microfluidic device of claim 9, wherein the silicon-based hydrophobic polymer is PDMS, and the copolymer comprises a PDMS-PEG copolymer.

29. The microfluidic device of claim 9, wherein the coating composition comprises from 0.1% to 5% of the copolymer.
